(19) United States
(12) Patent Application Publication
(10) Pub. No.: US 2009/0107391 A1
(43) Pub. Date: Apr. 30, 2009

(54) Combined State Of Charge Meter And Fuel Gauge

(75) Inventors: Joseph Brady, Augusta, GA (US); Kent H. Bruntz, Evans, GA (US); Oliver A. Bell, Aiken, SC (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/960,822

(22) Filed: Dec. 20, 2007

Related U.S. Application Data
(60) Provisional application No. 60/983,984, filed on Oct. 31, 2007.

(51) Int. Cl. G01D 11/00

(52) U.S. Cl. 116/200

(57) ABSTRACT

A vehicle meter can include first and second inputs and a gauge. The first input can be configured to receive a fuel level value from a fuel system. The second input can be configured to receive a power level value from a battery system. The gauge can be configured to display one of the fuel level or the power level. The gauge can display the fuel level when the first input is in communication with the fuel system and the power level value when the second input is in communication with the battery system.

### CROSS-REFERENCE TO RELATED APPLICATIONS

This application claims the benefit of U.S. Provisional Application No. 60/983,984, filed on Oct. 31, 2007. The disclosure of the above application is incorporated herein by reference.

### FIELD

The present disclosure relates to golf cars, and more specifically to battery charge and fuel meters for golf cars.

### BACKGROUND

The statements in this section merely provide background information related to the present disclosure and may not constitute prior art.

Golf cars typically are powered by either liquid fuel systems, such as gasoline or diesel fuel, or batteries. A fuel level gauge is usually provided for golf cars powered by liquid fuels. A state of charge meter is usually provided for golf cars powered by batteries. The general structure, including the instrument panel, of golf cars powered by different sources is often similar. However, as mentioned above, separate meters or gauges are used to indicate power or fuel levels of the golf cars. This results in more costly and complicated manufacturing and assembly of golf cars.

### SUMMARY

According to the present disclosure, a vehicle meter can include first and second inputs and a gauge. The first input can be configured to receive a fuel level value from a fuel system. The second input can be configured to receive a power level value from a battery system. The gauge can be configured to display one of the fuel level or the power level. The gauge can display the fuel level when the first input is in communication with the fuel system and the power level value when the second input is in communication with the battery system.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car including a meter according to the teachings of the present disclosure;

FIG. 2 is a fragmentary front plan view of the instrument panel of the golf car of FIG. 1;

FIG. 3 is a perspective view of the meter of FIG. 1;

FIG. 4 is an end plan view of the meter of FIG. 3;

FIG. 5 is a schematic illustration of a connection between the meter of FIG. 3 and liquid fuel and oil systems; and

FIG. 6 is a schematic illustration of a connection between the meter of FIG. 3 and a battery system.

### DETAILED DESCRIPTION

The following description is merely exemplary in nature and is in no way intended to limit the present disclosure, application, or uses. Throughout this specification, like reference numerals will be used to refer to like elements.

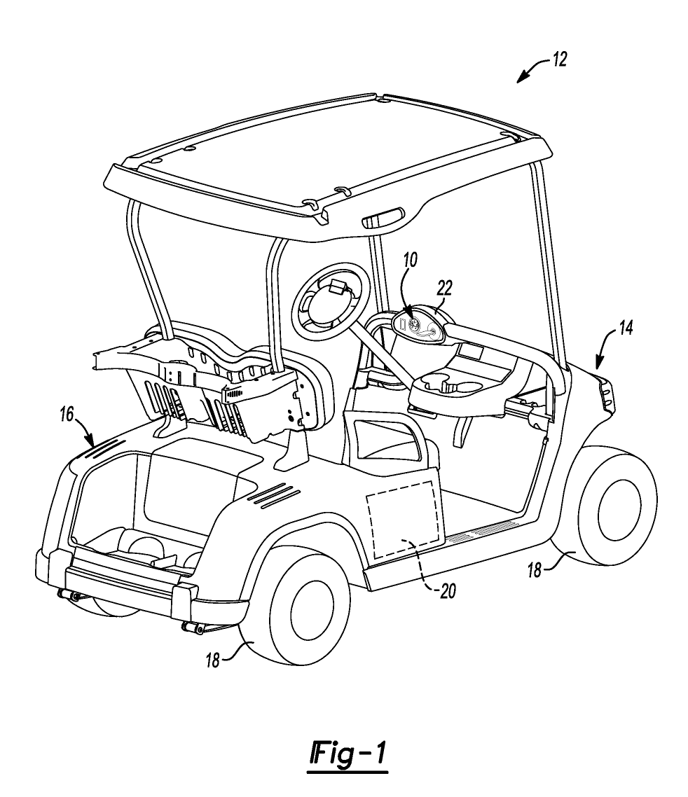

With initial reference to FIG. 1, a vehicle meter constructed in accordance to the present disclosure is shown and identified generally at reference numeral 10. Vehicle meter 10 is illustrated operably connected to an exemplary golf car 12. It is appreciated that golf car 12 is merely exemplary and that vehicle meter 10 can be adapted for use with other golf car configurations. Furthermore, vehicle meter 10 described herein is not limited for use with golf cars and can also be used with other vehicles such as, but not limited to, utility vehicles, lawnmowers, and other turf care vehicles.

Golf car 12 can include front and rear portions 14, 16 and wheels 18 drivingly coupled thereto. A motor (not shown) can provide for driving of wheels 18. The motor can be in communication with a fuel supply 20. Fuel supply 20 can include a variety of power sources, such as liquid fuel (gasoline or diesel) and batteries, as discussed below.

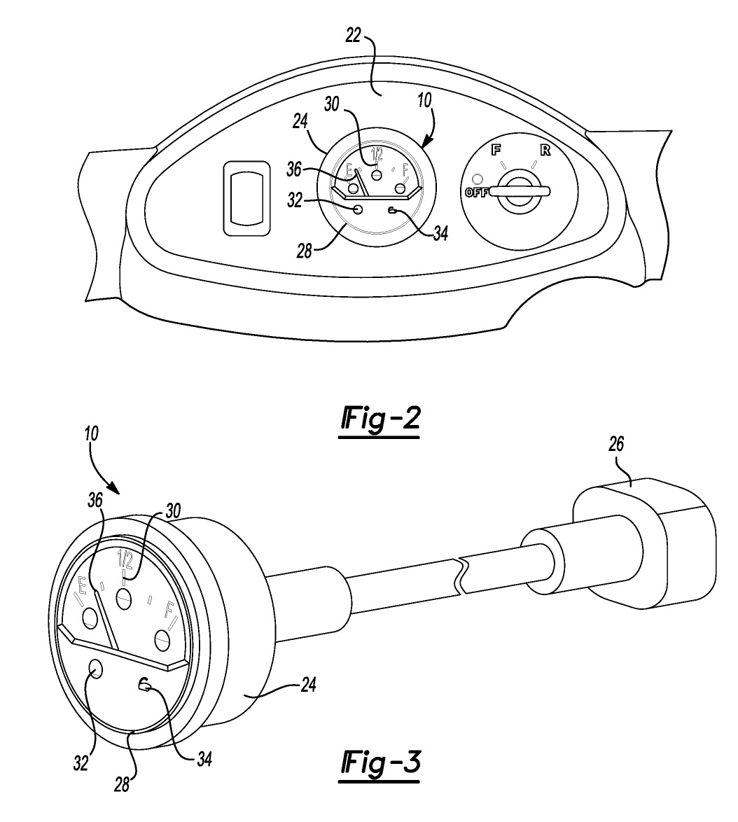

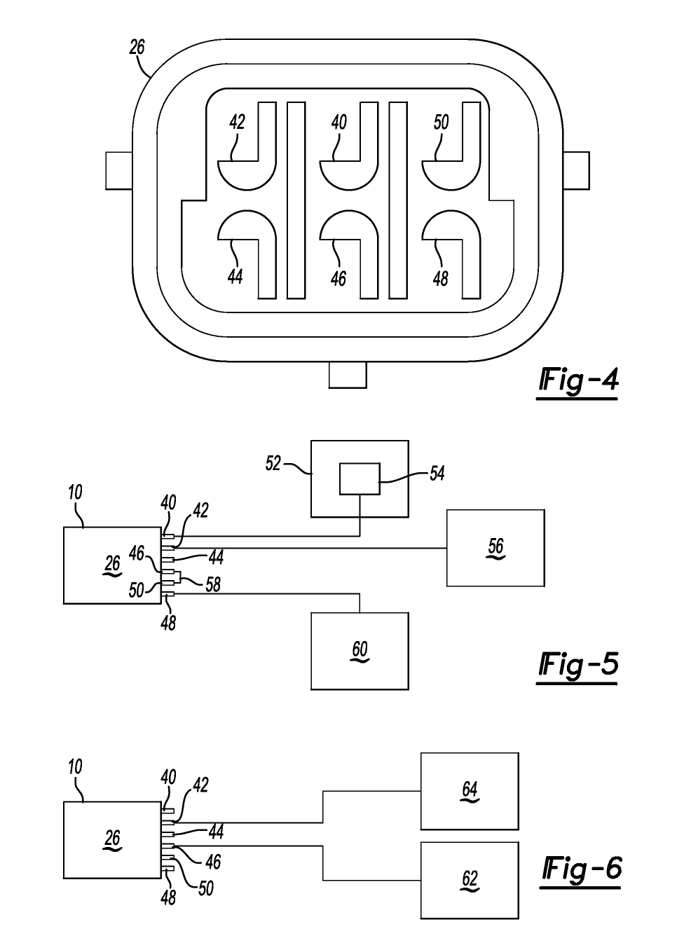

With additional reference to FIGS. 2-4, front portion 14 of golf car 12 can include an instrument panel 22 containing vehicle meter 10 therein. Vehicle meter 10 can include a display portion 24 and a terminal portion 26. Display portion 24 can include a gauge face 28 having fuel or charge level indicia 30, a low fuel indicator 32, and a low oil indicator 34 thereon. Display portion 24 can further include a pointer 36 movably coupled to gauge face 28 for indicating a fuel or charge level according to the fuel or charge level indicia 30. Terminal portion 26 can include pins 40, 42, 44, 46, 48, 50.

With additional reference to FIG. 5, vehicle meter 10 is shown connected to a liquid fuel system 52. Liquid fuel system 52 can include gasoline or diesel fuels. Liquid fuel system 52 can include a fuel sender 54 in communication with terminal portion 26 of vehicle meter 10. In this arrangement, pin 40 can receive an input from fuel sender 54. Pin 42 can be in communication with a power source 56. Pin 42 can receive an operation voltage of between 10 and 15 volts DC. Vehicle meter 10 can have a current consumption of up to 40 mA. Pin 44 can be a ground. Pins 46 and 50 can include a wire jumper 58 therebetween. Pin 48 can be in communication with an oil system 60 and can receive an oil level input.

Alternatively, as seen in FIG. 6, terminal portion 26 of vehicle meter 10 can be connected to a battery system 62. Pin 42 can be in communication with a power source 64. In this arrangement, pin 42 can receive an operation voltage of between 10 and 63 volts DC. Power source 64 can be part of battery system 62. Vehicle meter 10 can have a current consumption of up to 40 mA. Pin 44 can be a ground. Pin 46 can receive a controller input voltage from battery system 62 generally indicating a battery power level (or state of charge). The controller input voltage can generally be between 0.5 and 4.5 volts.

As discussed and shown above, vehicle meter 10 can be used for both liquid fuel (gasoline and diesel) and battery powered golf cars. During assembly, a common vehicle meter can therefore be used, allowing for connection to either liquid fuel systems (shown in FIG. 5) or battery powered systems (shown in FIG. 6) using the same vehicle meter 10 and corresponding terminal portion 26.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A vehicle meter comprising:
a first input configured to receive a fuel level value from a fuel system;
a second input configured to receive a power level value from a battery system; and
a gauge configured to display one of the fuel level value or the power level value, said gauge configured to display the fuel level when said first input is in communication with the fuel system and the power level value when said second input is in communication with the battery system.

2. The vehicle meter of claim 1, further comprising a third input configured to receive an oil level value from an oil system.

3. The vehicle meter of claim 1, further comprising a power input configured to receive a power source.

4. The vehicle meter of claim 3, further comprising a ground.

5. The vehicle meter of claim 1, further comprising an indicia on said gauge, said indicia configured to be used for display of either the fuel level value or the power level value.

6. The vehicle meter of claim 1, wherein the power level value includes a state of charge value.

7. The vehicle meter of claim 1, wherein said first input is configured to receive a signal from a fuel sender.

8. A golf car comprising:
at least one of a fuel system or a battery system; and
a meter including a first input, a second input, and a gauge, said first input configured to receive a fuel level value from said fuel system, said second input configured to receive a power level value from said battery system, said gauge configured to display one of the fuel level value or the power level value, said gauge configured to display the fuel level value when said first input is in communication with said fuel system and the power level value when said second input is in communication with said battery system.

9. The golf car of claim 8, wherein said meter includes a third input in communication with an oil system and configured to receive an oil level value from said oil system.

10. The golf car of claim 8, wherein said meter includes a power input in communication with a power source.

11. The golf car of claim 10, wherein said meter includes a ground.

12. The golf car of claim 8, wherein said gauge includes an indicia configured to be used for display of either the fuel level value or the power level value.

13. The golf car of claim 8, wherein the power level value includes a state of charge value.

14. The golf car of claim 8, wherein said fuel system includes a fuel level sender, said first input in communication with said fuel level sender.

15. A vehicle comprising:
one of a fuel system or a battery system; and
a combined state of charge meter and fuel gauge configured to receive one of a fuel level value from said fuel system or a power level value from said battery system, said combined state of charge meter and fuel gauge including a display configured to provide a fuel level when in communication with said fuel system and to provide a power level when in communication with said battery system.

16. The vehicle of claim 15, wherein said display includes an indicia for displaying one of the fuel level and the power level.

17. The vehicle of claim 15, wherein said combined state of charge meter and fuel gauge is in communication with a power source.

18. The vehicle of claim 15, wherein said combined state of charge meter and fuel gauge includes a ground.

19. The vehicle of claim 15, wherein said combined state of charge meter and fuel gauge is in communication with an oil system and is configured to receive an oil level value from said oil system.

20. The vehicle of claim 15, wherein said vehicle is a golf car.
